(19) United States
(12) Patent Application Publication
(10) Pub. No.: US 2014/0184388 A1
(43) Pub. Date: Jul. 3, 2014

(54) END OF THE LINE DETECTION APPARATUS

(71) Applicants: William Thomas Van Loan, Marietta, GA (US); Mathew Daniel Simcock, Medway, MA (US)

(72) Inventors: William Thomas Van Loan, Marietta, GA (US); Mathew Daniel Simcock, Medway, MA (US)

(21) Appl. No.: 14/147,292

(22) Filed: Jan. 3, 2014

Related U.S. Application Data
(60) Provisional application No. 61/748,642, filed on Jan. 3, 2013.

(51) Int. Cl. G06K 7/10

(52) U.S. Cl. CPC G06K 7/10366
USPC 340/8.1

(57) ABSTRACT

An electronic resistor or end of the line power module device that includes a radio frequency identification (RFID) transmitter attached to assist in locating hard to find end of the line devices on supervised alarm system circuitry or non-supervised AC/DC power circuits. Since the RFID transmitter may be found using an RFID verifier, finding an end of the line device may now be easily accomplished.

### CROSS-REFERENCE TO RELATED APPLICATION

This application claims the benefit of priority of U.S. provisional application No. 61/748,642, filed Jan. 3, 2013, the contents of which are herein incorporated by reference.

### BACKGROUND OF THE INVENTION

The present invention relates to an end of the line detection apparatus and, more particularly, to a radio frequency identification tag attached to an end of the line device.

A resistor is a two-terminal electronic component that produces a voltage across its terminals that is proportional to the electric current passing through it in accordance with ohm's law: v=ir. Resistors are elements of electrical networks and electronic circuits and are ubiquitous in most electronic equipment. Practical resistors can be made of various compounds and films, as well as resistance wire (wire made of a high-resistivity alloy, such as nickel/chrome). The primary characteristics of a resistor are the resistance, the tolerance, maximum working voltage and the power rating.

End of line resistors (EOLR) are resistors of a specified value that are used to terminate protective loops or zones. The purpose of EOLR's is to allow the control panel to supervise the field wiring for open or short circuit conditions. How the alarm responds to each depends on the panel as well as system zone programming, but generally speaking, an alarm views an open circuit as a fault or alarm condition, and a short circuit as a trouble or alarm condition (if armed). The purpose of EOLR's is to allow the panel to differentiate between the two conditions by looking for a known resistance.

Occasionally, the end of the line resistors or end of the line power supervision modules need to be upgraded, repaired, or replaced. It may be difficult to locate hidden resistors, electronic devices or end-of-line devices located or terminated at the end of Class-B supervised alarm system circuitry or non-supervised AC/DC power circuits.

As can be seen, there is a need for an improved method and apparatus of detecting a end of the line devices.

### SUMMARY OF THE INVENTION

In one aspect of the present invention, an apparatus comprises: an end of the line device; and a radio frequency identification tag attached to the end of the line device.

In another aspect of the present invention, a method of detecting an end of the line device comprises: attaching a radio frequency identification tag to the end of the line device; installing the end of the line device in a supervised alarm system circuitry; embedding the supervised alarm system circuitry within a building; and using a radio frequency verifier to locate the radio frequency identification tag and thereby locate the end of the line device.

These and other features, aspects and advantages of the present invention will become better understood with reference to the following drawings, description and claims.

### BRIEF DESCRIPTION OF THE DRAWINGS

FIG. 1 is a perspective view of the present invention; and

FIG. 2 is a perspective view of the present invention being covered by an encapsulating device.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electronic resistor or end of the line electronic device that includes a radio frequency identification (RFID) transmitter attached to assist in locating hard to find end of the line resistors or end of the line power modules on supervised alarm system circuitry or non-supervised AC/DC power circuits. Since the RFID transmitter may be found using an RFID verifier, finding an end of the line resistor or power module may now be easily accomplished. Therefore, a field technician may easily find the end of the line device that is connected to a supervised alarm circuit.

Radio-frequency identification (RFID) is the use of an object (typically referred to as an RFID tag) applied to or incorporated into a product, animal, or person for the purpose of identification and tracking using radio waves. Some tags can be read from several meters away and beyond the line of sight of the reader. Radio-frequency identification comprises interrogators (also known as readers), and tags (also known as labels). Most RFID tags contain at least two parts. One is an integrated circuit for storing and processing information, modulating and demodulating a radio-frequency (rf) signal, and other specialized functions. The second is an antenna for receiving and transmitting the signal.

The present invention may include the following. An end of the line resistor or end of the line power module of any value or size may be attached to radio-frequency identification (RFID) tag. Any one of the three generally used types of RFID tags may be used. For example, the present invention may include: active RFID tags, which contain a battery and can transmit signals autonomously; passive RFID tags, which have no battery and therefore use an external source to provoke signal transmission; and battery assisted passive (bap) RFID tags, which use an external source to wake up but have significant higher forward link capability providing greater range. The (RFID) Tag can also be an unpowered NFC (Near Field Communications) Chip. Radio Frequency Identification (RFID) standards may include ISO/IEC 14443, ISO/IEC 18092, FeliCa ® and any other appropriate RFID standard.

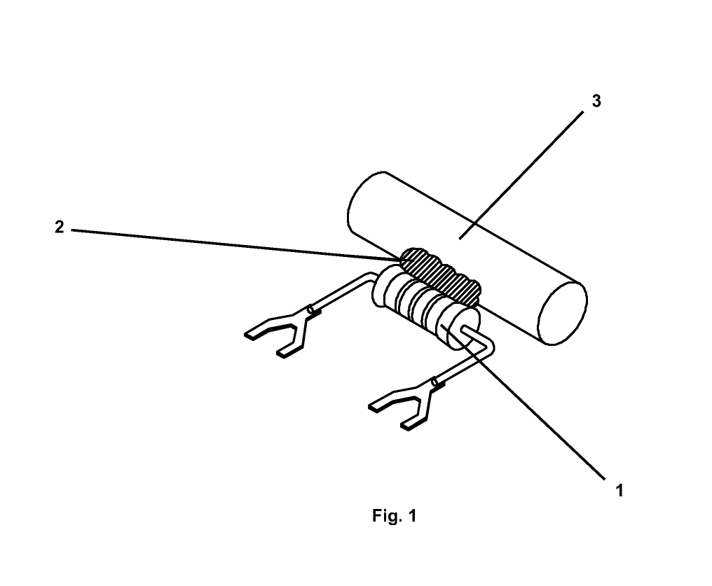

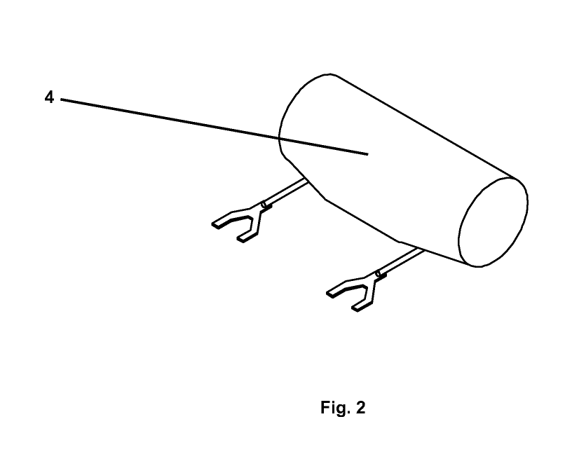

Referring to FIGS. 1 and 2, the present invention includes an end of the line device 1, such as a resistor or power module. A radio frequency identification tag 3 is attached to the end of the line device 1. The radio frequency identification tag 3 may be attached to the end of the line device by glue 2. In certain embodiments, the end of the line device 1 is part of a security system. In certain embodiments, the present invention may include an encapsulating device 4 removably covering the end of the line device 1 and the radio frequency identification tag 3.

A method of making the present invention may include the following. An RFID transmitter or NFC tag may be glued to an electronic resistor or other device, such as a power module. The attached components may be covered by an encapsulating compound. A method of using the present invention may include the following. The present invention may be connected in the same fashion as installing the current end of the line resistors or modules to supervised alarm circuitry, but now using the RFID transmitter with the end of the line resistor or module. The present invention may be mounted under two screw terminals on the back of an alarm industry peripheral device that uses circuit supervision.

A method of detecting a resistor or module may include the following:

attaching a radio frequency identification tag to the resistor or module; installing the resistor or module in a supervised alarm system circuitry; embedding the supervised alarm system circuitry within a building; and using a radio frequency verifier to locate the radio frequency identification tag and thereby locate the resistor or module.

It should be understood, of course, that the foregoing relates to exemplary embodiments of the invention and that modifications may be made without departing from the spirit and scope of the invention as set forth in the following claims.

What is claimed is:

1. An apparatus comprising:
an end of the line device; and
a radio frequency identification tag attached to the end of the line device.

2. The apparatus of claim 1, wherein the end of the line device is at least one of an end of the line resistor and an end of the line power module.

3. The apparatus of claim 1, wherein the end of the line device is part of a security system.

4. The apparatus of claim 1, wherein the radio frequency identification tag comprises at least one of an active radio frequency identification tag, a passive radio frequency identification tag, a battery assisted passive radio frequency identification tag, and a near field communications chip.

5. The apparatus of claim 1, further comprising an encapsulating device removably covering the end of the line device and the radio frequency identification tag.

6. The apparatus of claim 1, further comprising glue attaching the end of the line device to the radio frequency identification tag.

7. A method of detecting an end of the line device comprising:
attaching a radio frequency identification tag to the end of the line device;
installing the end of the line device in a supervised alarm system circuitry;
embedding the supervised alarm system circuitry within a building; and
using a radio frequency verifier to locate the radio frequency identification tag and thereby locate the end of the line device.

8. The method of claim 7, wherein the end of the line device is at least one of an end of the line resistor and an end of the line power module.
